(19) United States
(12) Patent Application Publication
(10) Pub. No.: US 2026/0005270 A1
(43) Pub. Date: Jan. 1, 2026

(54) Fuel Cell Vehicle

(71) Applicants: HYUNDAI MOTOR COMPANY, Seoul (KR); KIA CORPORATION, Seoul (KR)

(72) Inventors: Jae Kwon Jung, Hwaseong-si (KR); Sun Heum Baek, Hwaseong-si (KR); Jae Won Jang, Hwaseong-si (KR); Dae Jong Kim, Hwaseong-si (KR); Jae Won Jung, Hwaseong-si (KR)

(73) Assignees: HYUNDAI MOTOR COMPANY, Seoul (KR); KIA CORPORATION, Seoul (KR)

(21) Appl. No.: 18/955,156

(22) Filed: Nov. 21, 2024

(30) Foreign Application Priority Data
Jul. 1, 2024 (KR) 10-2024-0086247

(51) Int. Cl. H01M 8/04223; B60L 50/75; B60L 58/12; B60L 58/32; B60L 58/40; H01M 8/04007; H01M 8/04029; H01M 8/04119; H01M 8/04228; H01M 8/04303; H01M 8/0432; H01M 8/04701; H01M 8/04828; H01M 8/04858; H01M 16/00

(52) U.S. Cl. CPC H01M 8/04253; B60L 50/75; B60L 58/12; B60L 58/32; B60L 58/40; H01M 8/04029; H01M 8/04037; H01M 8/04126; H01M 8/04228; H01M 8/04303; H01M 8/0432; H01M 8/04358; H01M 8/04723; H01M 8/04828; H01M 8/0488; H01M 8/0494; H01M 8/04947; H01M 16/006; H01M 2220/20; H01M 2250/20

(57) ABSTRACT

A fuel cell vehicle is disclosed. The fuel cell vehicle includes a fuel cell stack, a battery configured to store power generated through a fuel cell stack, a heater configured to heat the cooling water using the power stored in the battery, and a controller periodically activated during power-off of a vehicle and deactivated after increasing the cooling water temperature through a heater until the cooling water temperature reaches a target temperature when heating conditions determined based on a cooling water temperature and an outside air temperature are satisfied in the activated state.

### CROSS-REFERENCE TO RELATED APPLICATION(S)

The present application claims priority to Korean Patent Application No. 10-2024 0086247, filed on Jul. 1, 2024, the entire contents of which is incorporated herein for all purposes by this reference.

### TECHNICAL FIELD

The present disclosure relates to a fuel cell vehicle configured to prevent residual water of a fuel cell stack from freezing due to an outside temperature in a state of power-off.

### BACKGROUND

Fuel cell vehicles generally adopt a fuel cell system including a stack for generating electric energy by electrochemical reactions of fuel and an oxidizer to generate power, a fuel supply device for supplying fuel gas to an anode of the stack through a fuel gas supply flow path, an air supply device for supplying oxygen-containing air to a cathode of the stack through an oxidizing gas supply flow path, a heat management device for controlling an operating temperature of the stack, and a control device for controlling an operation of the fuel cell system.

In such a fuel cell system, hydrogen, which is a fuel, is oxidized at the anode (oxidizing electrode) of the stack to generate hydrogen ions and electrons. The anode hydrogen ions pass through an electrolyte membrane and move to the cathode (reduction electrode), and at the cathode, oxygen is reduced to generate water. At this time, electrons move from the anode to the cathode through an external conducting wire to generate electrical energy.

Meanwhile, when residual water is present inside the fuel cell stack, the residual water may freeze when the outside temperature drops below zero (e.g., degrees), which may affect the durability of the stack. Therefore, it is necessary to propose a measure for preventing the durability effect due to the freezing of the residual water.

The matters explained as the background art are for the purpose of enhancing the understanding of the background of the present disclosure and should not be taken as acknowledging that they correspond to the related art already known to those skilled in the art.

### SUMMARY

The present disclosure is directed to preventing the durability effect due to cooling of residual water by heating a fuel cell stack based on a cooling water temperature and an outside air temperature in a power-off state of a vehicle or discharging residual water of the fuel cell stack.

The objects of the present disclosure are not limited to the above-described object, and other objects that are not mentioned will be able to be clearly understood by those skilled in the art from the following description.

A fuel cell vehicle according to one embodiment of the present disclosure. The fuel cell vehicle includes a fuel cell stack heated or cooled by cooling water, a battery configured to store power generated through a fuel cell stack, a heater configured to heat the cooling water using the power stored in the battery, and a controller periodically activated during power-off of a vehicle and deactivated after increasing the cooling water temperature through a heater until the cooling water temperature reaches a target temperature when heating conditions determined based on a cooling water temperature and an outside air temperature are satisfied in the activated state.

For example, the heating conditions may include a first heating condition satisfied when the cooling water temperature is lower than or equal to a first reference temperature that is preset in consideration of freezing of residual water of the fuel cell stack.

For example, the heating conditions may further include a second heating condition satisfied when the outside air temperature exceeds a preset second reference temperature, and the second reference temperature may be lower than the first reference temperature.

For example, the controller may discharge residual water of the fuel cell stack when the second heating condition is not satisfied.

For example, the heater may be a cathode oxygen depletion (COD) heater.

For example, when the heating conditions are satisfied, the controller may electrically connect a battery to the heater to operate the heater and circulates cooling water heated through the heater to the fuel cell stack side.

For example, the target temperature may be determined based on a preset first target temperature.

For example, the target temperature may be determined in further consideration of the outside air temperature.

For example, the target temperature may be determined by subtracting a compensation value determined based on the outside air temperature from the preset first target temperature.

For example, the controller may determine the target temperature by subtracting the compensation value from the first target temperature when the outside air temperature is within a preset temperature range, and the preset temperature range may be included within a range in which the outside air temperature and the cooling water temperature satisfy the heating conditions.

For example, the first target temperature may be set to correspond to each outside air temperature, and the target temperature may be determined to be the first target temperature corresponding to a current outside air temperature.

For example, the target temperature may be determined based on the heat capacity and heat transfer efficiency of the cooling water.

For example, when a state of charge (SOC) of a battery reaches a preset lower limit SOC in a process of increasing the cooling water temperature through the heater, the controller may charge a battery through power generation of the fuel cell stack until the SOC of the battery reaches a target SOC that is preset in consideration of power consumption of the heater.

For example, when the remaining amount of fuel for power generation of the fuel cell stack is smaller than a reference fuel amount that is preset in consideration of starting and traveling of a vehicle, the controller may discharge residual water of the fuel cell stack instead of charging the battery.

For example, when at least one of a preset cooling water heating count and cooling water heating maintenance time is satisfied, the controller may discharge the residual water of the fuel cell stack instead of charging the battery.

For example, the controller may predict an power-on time point of a vehicle, determine the possibility of performing heating up to the power-on time point based on an outside air temperature up to the power-on time point and the remaining amount of fuel for the power generation of the fuel cell stack, and when it is determined that heating is impossible up to the power-on time point, discharge the residual water of the fuel cell stack instead of charging the battery.

For example, when residual water of the fuel cell stack is discharged, the controller may not be activated to increase the cooling water temperature during power-off of a vehicle.

For example, the fuel cell vehicle may further include a humidifier configured to provide moisture to the fuel cell stack, and an air compressor configured to discharge the moisture of the humidifier and residual water of the fuel cell stack, wherein, when the residual water of the fuel cell stack is discharged, after the moisture of the humidifier is discharged to the outside through the air compressor in a state of disconnecting the fuel cell stack and the humidifier, the residual water may be discharged through the air compressor by connecting the fuel cell stack to the humidifier.

For example, the controller may maintain a voltage of the fuel cell stack at an open circuit voltage (OCV) in a process of discharging the residual water.

For example, the controller may reduce a voltage generated at the fuel cell stack after the residual water is discharged.

According to various embodiments of the present disclosure, it is possible to prevent the durability effect of the fuel cell stack due to the freezing of the residual water even when the outside air temperature of the vehicle drops to below zero in the power-off state.

In particular, it is possible to prevent the entry into the cold start when resuming power-on, through the heat management by the heating of the fuel cell stack in the power-off state, thereby shortening the starting time and securing the available output of the fuel cell stack to improve operability.

In addition, it is possible to minimize the discharge of the residual water through the heat management by the heating of the fuel cell stack, thereby reducing noise generation and freezing near the vehicle due to the discharged residual water.

The effects obtainable from the present disclosure are not limited to the above-described effects, and other effects that are not mentioned will be able to be clearly understood by those skilled in the art to which the present disclosure pertains from the following description.

### BRIEF DESCRIPTION OF THE DRAWINGS

FIG. 1 is a view showing a configuration of a fuel cell vehicle according to one embodiment of the present disclosure.

FIG. 2 is a view for describing a heating control process of control of the fuel cell vehicle according to one embodiment of the present disclosure.

FIG. 3 is a view for describing a target temperature in a fuel cell vehicle control process according to one embodiment of the present disclosure.

FIG. 4 is a view for describing battery charging conditions in the fuel cell vehicle control process according to one embodiment of the present disclosure.

FIG. 5 is a flowchart for describing a control process of the fuel cell vehicle according to one embodiment of the present disclosure.

### DETAILED DESCRIPTION

Specific structural and functional descriptions of the embodiments of the present disclosure disclosed in the specification or the application are merely illustrative for the purpose of describing the embodiments of the present disclosure, and the embodiments of the present disclosure may be implemented in various forms and should not be construed as being limited to the embodiments described in the specification or the application.

Since the embodiments of the present disclosure may be variously changed and may have various forms, specific embodiments will be illustrated in the drawings and described in detail in the specification or the application. However, it should be understood that this is not intended to limit the present disclosure to a specific form specifying the embodiments according to the concept of the present disclosure and includes all changes, equivalents, and substitutions included within the spirit and technical scope of the present disclosure.

Unless defined otherwise, all terms used herein, including technical or scientific terms, have the same meaning as commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in this document.

Hereinafter, embodiments disclosed in this specification will be described in detail with reference to the accompanying drawings, and the same or similar components are denoted by the same reference numerals regardless of the drawing symbols, and overlapping descriptions thereof will be omitted.

In the following description of the embodiments, the term “preset” means that a value of a parameter is predetermined when using the parameter in a process or an algorithm. According to the embodiments, the value of the parameter may be set when the process or the algorithm starts or set during a section in which the process or the algorithm is performed.

The suffixes “module” and “unit” for components used in the following description are given or used interchangeably in consideration of ease of preparing the specification and not have meanings or roles that are distinct from each other by themselves.

In describing the embodiments disclosed in the specification, when it is determined that a detailed description of a related known technology may obscure the gist of the embodiments disclosed in this specification, a detailed description thereof will be omitted. In addition, the accompanying drawings are only for easy understanding of the embodiments disclosed in the specification, and it should be understood that the technical spirit disclosed in the specification is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for the purpose of distinguishing one component from another.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that others components are not present therebetween.

The singular includes the plural unless the context clearly dictates otherwise.

In the specification, it should be understood that the term “comprise” or “have” is intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In addition, a unit or control unit included in the name of a fuel cell control unit (FCU) is the term widely used for naming a controller for controlling a specific function of a vehicle and does not mean a generic function unit.

A controller may include a communication device for communicating with another controller or a sensor to control a function in charge, a memory for storing an operating system or logic commands and input and output information, and one or more processors for performing determination, calculation, decision, and the like necessary for controlling the function in charge.

A fuel cell vehicle according to one embodiment of the present disclosure is proposed to control the heating of a stack based on a cooling water temperature and an outside air temperature of the fuel cell stack through a controller periodically activated in an power-off state of the vehicle, thereby preventing the durability effect due to freezing of residual water of the fuel cell stack even in the power-off state of the vehicle.

Hereinafter, the fuel cell vehicle according to one embodiment of the present disclosure will be described with reference to each drawing.

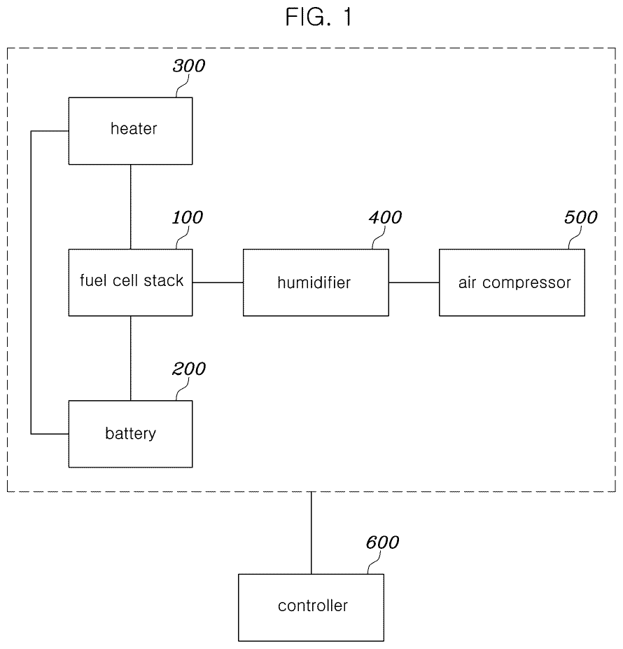

FIG. 1 is a view showing a configuration of a fuel cell vehicle according to one embodiment of the present disclosure.

Referring to FIG. 1, the fuel cell vehicle according to one embodiment of the present disclosure may include a fuel cell stack 100, a battery 200, a heater 300, a humidifier 400, an air compressor 500, and a controller 600 for controlling the above components. However, FIG. 1 mainly shows components related to the description of one embodiment of the present disclosure, and it goes without saying that an actual fuel cell vehicle may be implemented by including a larger or fewer number of components. Hereinafter, each component will be described in detail.

The fuel cell stack 100 may have cooling water together with an anode and/or a cathode, therein, and the cooling water may be used for heat management of the fuel cell stack 100 while circulating the cooling water in the fuel cell stack 100.

The battery 200 may store power generated through the fuel cell stack 100 and provide power stored for traveling of a vehicle or operating fuel cell accessories and/or electrical components.

The heater 300 may heat the cooling water using the power stored in the battery 200. In this case, the heater 300 may be, for example, a cathode oxygen depletion (COD) heater provided in a fuel cell system, and the COD heater may heat the cooling water by converting the power of the battery into heat energy through an internal resistor. Meanwhile, the fuel cell vehicle according to one embodiment of the present disclosure may have only the COD heater and may not have another heater that requires a separate fuel supply. However, the above is only one implementation example and may be implemented in various ways, such as having the COD heater and a heater different from the COD heater together.

When heating conditions are satisfied, the heater 300 may be operated by being electrically connected to the battery 200 by the controller 600, and in this case, the controller 600 may circulate the cooling water heated by the heater 300 to the fuel cell stack 100 (e.g., side).

The humidifier 400 may supply moisture to the fuel cell stack 100, and to this end, may be connected to the fuel cell stack 100. In one embodiment, a valve for mutual connection or disconnection may be provided between the fuel cell stack 100 and the humidifier 400.

The air compressor 500 may generate an air pressure to discharge the moisture of the humidifier 400 or discharge residual water of the fuel cell stack 100, and to this end, may be connected to the fuel cell stack 100 and the humidifier 400. In one embodiment, a valve for mutual connection or disconnection may be provided between the humidifier 400 and the air compressor 500.

After the moisture of the humidifier 400 is discharged through the air compressor 500 in a state in which the fuel cell stack 100 and the humidifier 400 have been blocked, the residual water of the fuel cell stack 100 may be discharged to the outside through the air pressure of the air compressor 500 by connecting the fuel cell stack 100 to the humidifier 400. Such a process may be performed through the controller 600.

In addition, the controller 600 can prevent power and moisture from being generated by the introduction of air into the fuel cell stack 100 by maintaining a voltage of the fuel cell stack 100 at an open circuit voltage (OCV) in the process of discharging the residual water. After the residual water is discharged, the controller 600 reduces a voltage generated at the fuel cell stack 100.

Meanwhile, in the fuel cell vehicle according to one embodiment, the controller 600 is periodically activated during the power-off of the vehicle, and when heating conditions determined based on a cooling water temperature and an outside air temperature are satisfied in the activated state, the controller 600 may be deactivated after heating the cooling water temperature through the heater until the cooling water temperature reaches a target temperature.

To this end, the controller 600 may receive sensor values for the cooling water temperature of the fuel cell stack 100 and the outside air temperature from temperature sensors provided in the vehicle.

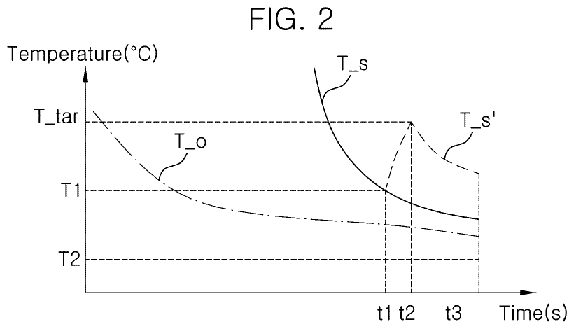

A process in which the controller 600 determines the heating conditions will be described below with reference to FIG. 2.

FIG. 2 is a view for describing a heating control process of control of the fuel cell vehicle according to one embodiment of the present disclosure.

FIG. 2 shows a graph of a temperature T_s of the fuel cell stack and an outside air temperature T_o, in which a horizontal axis represents a time and a vertical axis represents a temperature, and here, a cooling water temperature of the fuel cell stack 100 may be applied as the temperature of the fuel cell stack 100. Hereinafter, the heating conditions for preventing the freezing of the residual water of the fuel cell stack will be described in detail with reference to FIG. 2.

First, the heating conditions that are a determination target of the controller 600 may include a first heating condition that is satisfied when the cooling water temperature T_s is lower than or equal to a first reference temperature T1 that is preset in consideration of the freezing of the residual water of the fuel cell stack. In this case, the first reference temperature T1 may be, for example, ‘0’ degrees at which the residual water of the fuel cell stack 100 freezes. Through the first heating condition, heating may be performed in a state in which a temperature difference between the cooling water temperature T_s and the outside air temperature T_o is (e.g., excessively) large, thereby preventing the inefficiency of promoting the cooling of the residual water.

In addition, the outside air temperature is additionally considered in the heating conditions, and in this case, the heating conditions may further include a second heating condition that is satisfied when the outside air temperature T_o exceeds a second reference temperature T2. In this case, the second reference temperature T2 may be set to be lower than the first reference temperature T1 and set by an experimental value. For example, the second reference temperature T2 may be fifteen degrees.

That is, in one embodiment, the heating conditions may be satisfied when the cooling water temperature T_s is lower than or equal to the first reference temperature T1 and the outside air temperature T_o exceeds the second reference temperature T2. Referring to the graph of FIG. 2, the cooling water temperature T_s decreases and then increases at a time point t1 when reaching the first reference temperature T1, and continuously increases up to a time point t2 when the cooling water temperature reaches a target temperature T_tar.

Compared to a case in which the cooling water temperature is not increased (T_s), in a case in which the cooling water temperature is increased (T_s′), the cooling water temperature may be maintained at the first reference temperature T1 or higher set in consideration of the freezing of the residual water. At a subsequent restart time point t3, the fuel cell stack may enter a normal start without entering a cold start because it maintains a state in which the residual water does not freeze. On the other hand, in a case in which heating is not performed, the fuel cell stack may enter the cold start because it is in a low-temperature state at the restart time point t3.

Meanwhile, when the second heating condition is not satisfied, that is, when the outside air temperature T_o is lower than or equal to the second reference temperature T2, the controller 600 may discharge the residual water of the fuel cell stack 100 without increasing the cooling water temperature. Therefore, it is possible to prevent the inefficiency of generating excessive heat to thaw the already frozen residual water in a state in which the outside air temperature T_o is too low.

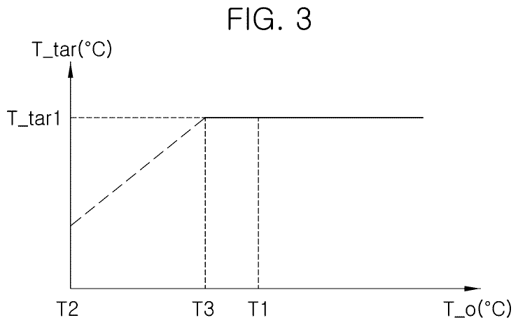

Meanwhile, the target temperature related to an end time point of the heating will be described below with reference to FIG. 3.

FIG. 3 is a view for describing a target temperature in a fuel cell vehicle control process according to one embodiment of the present disclosure.

FIG. 3 shows a graph in which a horizontal axis represents the outside air temperature T_o and a vertical axis represents the target temperature T_tar.

In one embodiment, the target temperature T_tar may be determined based on a preset first target temperature T_tar1. In this case, the first target temperature T_tar1 may be determined by experimental values related to the sustainability and energy efficiency of the heated state and may be, for example, ten degrees.

In addition, for the target temperature T_tar, the outside air temperature T_o may be further considered. More specifically, the target temperature T_tar may be determined by subtracting a compensation value determined based on the outside air temperature T_o from the preset first target temperature T_tar1.

In this case, the controller 600 determines the target temperature T_tar by subtracting the compensation value from the first target temperature T_tar1 when the outside air temperature T_o is within a preset temperature range, and the preset temperature range may be included in a range in which the outside air temperature and the cooling water temperature satisfy the heating conditions.

To this end, as shown in the graph of FIG. 3, the preset temperature range may have the second reference temperature T2 as a lower limit and a third reference temperature T3 between the second reference temperature T2 and the first reference temperature T1 as an upper limit. For example, the third reference temperature T3 may be determined to be minus five degrees when the first reference temperature T1 is zero degrees and the second reference temperature T2 is minus 15 degrees.

A method of determining the target temperature as described above may be represented by the following equation.

$$T\_tar = T\_tar1 - a ( - T 3 - T\_o )$$

Here, “a” denotes a compensation coefficient, which may be determined by an experimental value, and for example, the compensation coefficient may be 0.3.

When the target temperature is determined in the above-described manner, the target temperature T_tar is determined to be a first target temperature T_tar1 near the first reference temperature T1 and has a value smaller than the first target temperature T_tar1 in the preset temperature ranges T2 and T3 with respect to the outside air temperature. Therefore, the heating may be performed by reflecting the most appropriate target temperature in each outside air temperature state.

Meanwhile, the target temperature applicable to the embodiments of the present disclosure is not necessarily determined in the above manner, and various other methods may also be applied.

For example, the target temperature is determined based on the first target temperature, and the first target temperature may be set to correspond to each outside air temperature, and in this case, the target temperature may be determined to be the first target temperature corresponding to a current outside air temperature.

As another example, the target temperature may be determined based on the heat capacity and heat transfer efficiency of cooling water, and in this case, a heat generation amount of the heater 300 and/or a current cooling water temperature may be further considered.

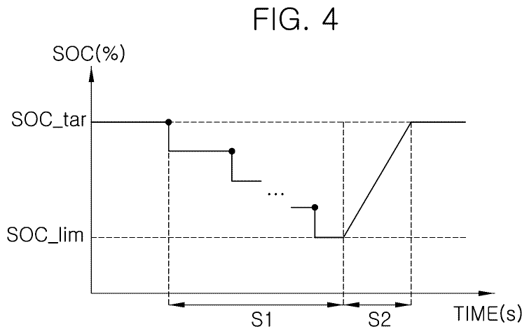

Meanwhile, in the heating process, the power of the battery 200 is consumed, and the power consumption of the battery 200 leads to the SOC of the battery 200, and thus the fuel cell vehicle according to one embodiment of the present disclosure may perform heating control in further consideration of the SOC of the battery 200. The above will be described below with reference to FIG. 4.

FIG. 4 is a view for describing battery charging conditions in the fuel cell vehicle control process according to one embodiment of the present disclosure.

FIG. 4 shows a graph of a change in SOC of the battery 200, in which a horizontal axis represents a time and a vertical axis represents an SOC.

When the SOC of the battery 200 reaches a preset lower limit SOC SOC_lim, in a process of increasing the cooling water temperature through the heater 300, the controller 600 may charge the battery 200 through the power generation of the fuel cell stack 100 until the SOC of the battery 200 reaches a preset target SOC SOC_tar. In this case, the target SOC SOC_tar may be set in consideration of the power consumption of the heater 300 and may be, for example, 60%. In addition, the lower limit SOC SOC_lim may be set in consideration of the target SOC SOC_tar and may be, for example, 40%.

In the graph of FIG. 4, in a first section S1, as the cooling water temperature is repeatedly increased through the heater 300, the SOC of the battery 200 gradually decreases. Then, when the SOC of the battery 200 decreases and reaches the lower limit SOC SOC_lim, the controller 600 may charge the battery 200 through the power generation of the fuel cell stack 100 during a second section S2 that is from a time point when the SOC of the battery 200 reaches the lower limit SOC SOC_lim until the SOC of the battery 200 reaches the target SOC, thereby maintaining the SOC of the battery 200 at a predetermined level even when heating control is performed during power-off.

Meanwhile, when a remaining amount of fuel for the power generation of the fuel cell stack 100 is smaller than a reference fuel amount that is preset in consideration of the starting and traveling of the vehicle, the controller 600 may discharge the residual water of the fuel cell stack 100 instead of charging the battery 200.

That is, in this case, since the remaining amount of fuel for charging the battery 200 is insufficient to satisfy the SOC of the battery 200 for increasing the cooling water temperature, the residual water may be discharged instead of incompletely performing heating, thereby preventing the occurrence of the durability effect of the fuel cell stack 100 due to the freezing of the residual water.

For example, the reference fuel amount may include the amount of fuel required to secure a preset minimum distance-to-empty of the vehicle.

In addition, the controller 600 may discharge the residual water of the fuel cell stack 100 instead of charging the battery 200 when at least one of the preset cooling water heating count and cooling water heating maintenance time is satisfied. The cooling water heating count and the cooling water heating maintenance time may be set by a vehicle user such as a driver. Therefore, control may be performed by reflecting the user's intention for maintaining the vehicle state and saving fuel through the heating of the fuel cell stack 100. In this case, information such as the cooling water heating count and the cooling water heating maintenance time may be input through a cluster, audio, video, navigation, and/or telematics (AVNT) device. that are provided in the vehicle.

In addition, the controller 600 may predict an power-on time point of the vehicle, determine the possibility of performing heating up to the power-on time point based on an outside air temperature up to the power-on time point and the remaining amount of fuel for the power generation of the fuel cell stack, and when it is determined that heating is impossible up to the power-on time point, discharge the residual water of the fuel cell stack instead of charging the battery.

In this case, the controller 600 may predict the power-on time point of the vehicle based on the previously stored traveling history of the vehicle and determine the outside air temperature up to the power-on time point based on weather information acquired through communication with the outside.

Meanwhile, in a case in which the residual water of the fuel cell stack 100 is discharged due to various conditions as described above, the heating control for preventing the freezing of the residual water is no longer needed, and thus when the residual water of the fuel cell stack 100 is discharged, the controller 600 may not be activated to increase the cooling water temperature during the power-off of the vehicle.

Hereinafter, the entire control process of the above-described fuel cell vehicle will be described with reference to a flowchart.

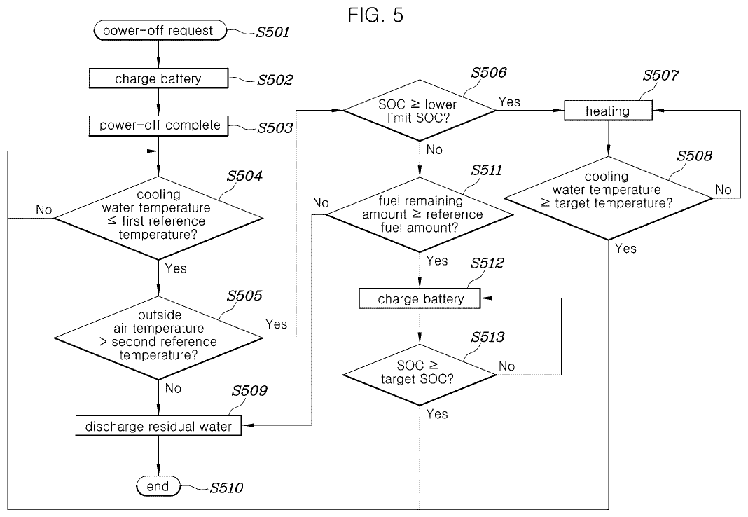

FIG. 5 is a flowchart for describing a control process of the fuel cell vehicle according to one embodiment of the present disclosure.

Referring to FIG. 5, when a power-off request of the vehicle occurs (S501), the controller 600 may forcibly charge the battery 200 through the fuel cell stack 100 so that the SOC of the battery 200 becomes a predetermined state (S502) and determine that the power-off of the vehicle has been ended when the charging is completed (S503). In this case, the controller 600 may forcibly charge the battery 200 to, for example, the above-described target SOC.

After power-off is ended, the controller 600 may determine whether the heating conditions are satisfied, and in this case, the heating conditions may include the first heating condition and the second heating condition.

The controller 600 may determine that the first heating condition is satisfied when the cooling water temperature is lower than or equal to the first reference temperature (Yes in S504) and determine that the second heating condition is satisfied when the outside air temperature exceeds the second reference temperature (Yes in S505). The sequence relationship between the determination of the first heating condition and the determination of the second heating condition is irrelevant, and the first heating condition and the second heating condition may be determined simultaneously.

The controller 600 may determine that the heating conditions are satisfied when both the first heating condition and the second heating condition are satisfied and in this case, determine whether the SOC of the battery 200 for heating is sufficient (S506). As a result of the determination, the controller 600 increases the cooling water temperature through the heater 300 (S507) when the SOC of the battery 200 is higher than the lower limit SOC (Yes in S506).

The heating continues while the cooling water temperature is lower than the target temperature (No in S508), and when the cooling water temperature is higher than or equal to the target temperature, is stopped until the heating conditions are re-satisfied (Yes in S508).

Meanwhile, unlike the above, when the second heating condition is not satisfied (No of S505), the controller 600 discharges the residual water of the fuel cell stack 100 instead of increasing the cooling water temperature (S509). Once the residual water is discharged, there is no longer a need to perform the controller for preventing the freezing of the residual water, and thus the controller 600 ends the control process and no longer performs the heating control or the residual water discharge control and does not perform periodic activation for the heating control and the residual water discharge control (S510).

In addition, when the SOC of the battery 200 is smaller than the lower limit SOC (No in S506), the controller 600 may compare the remaining fuel amount with the reference fuel amount to determine whether the battery 200 may be charged and when the remaining fuel amount is larger than or equal to the reference fuel amount (Yes in S511), charge the battery 200 through the fuel cell stack 100 (S512). In this case, the charging of the battery 200 continues while the SOC of the battery 200 is smaller than the target SOC (No in S513) and may be completed when the SOC of the battery 200 is larger than or equal to the target SOC (Yes in S513). After the charging of the battery 200 is completed, the process of determining the heating conditions is repeated.

Meanwhile, when the remaining fuel amount for the power generation of the fuel cell stack 100 is smaller than the reference fuel amount (No in S511), the cooling water temperature may not be fully increased, and thus the controller 600 may discharge the residual water of the fuel cell stack 100 instead of charging the battery 200 (S509). In this case, the control process is ended as in the case in which the second heating condition is not satisfied and thus the residual water is discharged (S510).

According to various embodiments of the present disclosure, it is possible to prevent the durability effect of the fuel cell stack due to the freezing of the residual water even when the outside air temperature of the vehicle drops to below zero in the power-off state.

In particular, it is possible to prevent the entry into the cold start when resuming power-on, through the heat management by the heating of the fuel cell stack in the power-off state, thereby shortening the starting time and securing the available output of the fuel cell stack to improve operability.

In addition, it is possible to minimize the discharge of the residual water through the heat management by the heating of the fuel cell stack, thereby reducing noise generation and freezing near the vehicle due to the discharged residual water.

Although the specific embodiments of the present disclosure have been illustrated and described above, it will be apparent to those skilled in the art that the present disclosure may be variously improved and changed without departing from the technical spirit of the present disclosure provided by the appended claims.

What is claimed is:

1. A fuel cell vehicle comprising:
a fuel cell stack heated or cooled by cooling water;
a battery configured to store power generated through the fuel cell stack;
a heater configured to heat the cooling water using the power stored in the battery; and
a controller periodically activated during power-off of the vehicle, and deactivated after increasing the cooling water temperature through the heater until the cooling water temperature reaches a target temperature when heating conditions determined based on the cooling water temperature and an outside air temperature are satisfied in an activated state.

2. The fuel cell vehicle of claim 1, wherein the heating conditions include a first heating condition satisfied when the cooling water temperature is lower than or equal to a first reference temperature that is preset in consideration of freezing of residual water of the fuel cell stack.

3. The fuel cell vehicle of claim 2, wherein the heating conditions further include a second heating condition satisfied when the outside air temperature exceeds a preset second reference temperature, and
the second reference temperature is lower than the first reference temperature.

4. The fuel cell vehicle of claim 3, wherein the controller is configured to discharge residual water of the fuel cell stack when the second heating condition is not satisfied.

5. The fuel cell vehicle of claim 1, wherein the heater is a cathode oxygen depletion (COD) heater.

6. The fuel cell vehicle of claim 5, wherein, when the heating conditions are satisfied, the controller electrically connects the battery to the heater to operate the heater and circulates cooling water heated through the heater to a side of the fuel cell stack.

7. The fuel cell vehicle of claim 1, wherein the target temperature is determined based on a preset first target temperature.

8. The fuel cell vehicle of claim 7, wherein the target temperature is determined in further consideration of the outside air temperature.

9. The fuel cell vehicle of claim 8, wherein the target temperature is determined by subtracting a compensation value determined based on the outside air temperature from the preset first target temperature.

10. The fuel cell vehicle of claim 9, wherein the controller is configured to determine the target temperature by subtracting the compensation value from the preset first target temperature when the outside air temperature is within a preset temperature range, and
the preset temperature range is included within a range in which the outside air temperature and the cooling water temperature satisfy the heating conditions.

11. The fuel cell vehicle of claim 8, wherein the preset first target temperature is set to correspond to each outside air temperature, and
the target temperature is determined to be the preset first target temperature corresponding to a current outside air temperature.

12. The fuel cell vehicle of claim 1, wherein the target temperature is determined based on a heat capacity and heat transfer efficiency of the cooling water.

13. The fuel cell vehicle of claim 1, wherein, when a state of charge (SOC) of the battery reaches a preset lower limit SOC while increasing the cooling water temperature through the heater, the controller charges the battery through power generation of the fuel cell stack until the SOC of the battery reaches a target SOC that is preset in consideration of power consumption of the heater.

14. The fuel cell vehicle of claim 13, wherein, when the remaining amount of fuel for power generation of the fuel cell stack is smaller than a reference fuel amount that is preset in consideration of starting and traveling of the vehicle, the controller discharges residual water of the fuel cell stack instead of charging the battery.

15. The fuel cell vehicle of claim 13, wherein, when at least one of a preset cooling water heating count and cooling water heating maintenance time is satisfied, the controller discharges residual water of the fuel cell stack instead of charging the battery.

16. The fuel cell vehicle of claim 13, wherein the controller is configured to predict an power-on time point of the vehicle, determine a possibility of performing heating up to the power-on time point based on the outside air temperature up to the power-on time point and the remaining amount of fuel for the power generation of the fuel cell stack, and when it is determined that heating is impossible up to the power-on time point, discharges residual water of the fuel cell stack instead of charging the battery.

17. The fuel cell vehicle of claim 1, wherein, when residual water of the fuel cell stack is discharged, the controller is not activated to increase the cooling water temperature during power-off of the vehicle.

18. The fuel cell vehicle of claim 1, further comprising:
a humidifier configured to provide moisture to the fuel cell stack; and
an air compressor configured to discharge the moisture of the humidifier and residual water of the fuel cell stack,
wherein, when discharging residual water of the fuel cell stack, the controller connects the fuel cell stack and the humidifier and discharges residual water of the fuel cell stack through the air compressor, after discharging the moisture of the humidifier to outside through the air compressor in a state of disconnecting the fuel cell stack and the humidifier.

19. The fuel cell vehicle of claim 18, wherein the controller is configured to maintain a voltage of the fuel cell stack at an open circuit voltage (OCV) while discharging residual water of the fuel cell stack.

20. The fuel cell vehicle of claim 18, wherein the controller is configured to reduce a voltage generated at the fuel cell stack after residual water of the fuel cell stack is discharged.
